(19) United States
(12) Patent Application Publication
(10) Pub. No.: US 2011/0171604 A1
(43) Pub. Date: Jul. 14, 2011

(54) Method for manufacturing and supply of dental prosthesis

(76) Inventors: Duane Milford Durbin, San Diego, CA (US); Laurence Warden, Poway, CA (US); Cory McCluskey, Encinitas, CA (US)

(21) Appl. No.: 12/655,886

(22) Filed: Jan. 11, 2010

(51) Int. Cl. A61C 13/08; G06F 19/00

(52) U.S. Cl. 433/213; 433/214; 700/98

(57) ABSTRACT

Systems and methods are disclosed for manufacturing a dental restorative prosthesis by capturing 3D dental data from a patient; sending the 3D dental data to a laboratory for fabricating a restoration blank, the blank having material below a preparation area; receiving the restoration blank from the laboratory; determining a reduction area from the patient during an in office visit and fabricating the reduction area from the restoration blank to match the patient dentition.

### BACKGROUND

A dental prosthesis refers to permanent crowns, bridges, inlays and onlays manufactured using specialized hard, durable materials. Common materials for fabricating dental prosthesis include, but are not limited to, Zirconia, Alumina, and Lithium Disillicate.

The most common method of producing a dental prosthesis involves a process whereby conventionally, a three-dimensional negative model of the teeth and other dental structures is created during an impression-taking session where one or more arch shaped trays are filled with a dental impression material. Impression materials include, among others, compositions based on alginates, polysulphides, silicones and vulcanizable polyether materials. The impression material is typically prepared by mixing a base component and a hardener or initiator or catalyst component. The impression tray containing the impression material, in its plastic state, is introduced into the mouth of the patient and pressed over the dentition. To ensure a complete impression, an excessive amount of impression material is typically used. While the tray and impression material is held in place, the impression material is allowed to solidify and form an elastomeric composition, which is the negative mold of the patient's dentition.

After the impression material has solidified, the tray and material are pulled off the dentition and removed from the mouth as a unit. Typically, the negative impression is sent by the dentist to a dental laboratory where it used by a dental technician to create a dental working model of the patient's dentition. Generally, the dentist also provides the dental laboratory with information regarding the desired shading and translucency for the dental prosthesis so that the prosthesis will provide an aesthetically acceptable appearance for the patient.

Because it may take a week or two for the laboratory to process the case and return the final dental prosthesis to the dentist office, a temporary prosthesis is often fabricated from a polymer based-material and fit to the patient to cover the prepared teeth while the final dental prosthesis is being manufactured by the dental laboratory lab.

Once the dental impression is received at a dental laboratory, a dental technician casts a non-flexible plaster positive model cast “stone” dental working model from the elastomeric negative impression. The stone working model is then sectioned to separate the teeth being restored. The separated teeth are typically placed on posts or pins and corresponding holes are drilled into the stone model base so they can be inserted and removed as needed during the dental prosthesis fabrication process.

For dental prosthesis being fabricated using Computer Aided Design (CAD) and Computer Aided Manufacturing (CAM) processes, the separated teeth and main stone model are converted into a digital surface representation that can be digitally processed in a computer. This conversion to a digital surface representation is commonly performed using laser-based triangulation scanning system or a Coordinate Measurement Machine (CMM) touch probe.

Once the dental working model is digitized into the computer, CAD software is used to design the dental prosthesis using the digitized model of the patient's dentition to define the interface surfaces of the prepared teeth and adjacent/opposing teeth. In this context, the term prepared teeth means that the patient's tooth or teeth surface(s) has been ground down with a dental burr or in some other way been altered by the dentist in preparation for receiving a dental prosthesis. Given that the digital impression data is conventionally captured after the tooth being treated has been prepared, the general CAD design of the final external shape and anatomy of the dental prosthesis is largely based on a digital library of teeth shapes rather than the exact baseline shape and anatomy of the patient's tooth before it was prepared for the restoration treatment. Following the CAD design step, the dental prosthesis data file is transferred to a computer controlled milling machine for fabrication of the dental prosthesis.

Typically, the dental prosthesis is milled from a “green” semi-hardened state ceramic material such as zirconia, alumina, or lithium-disilicate. This green state material is easily machined, but requires additional heat treating (sintering) after machining to achieve full hardness required for use as a dental prosthesis. The sintering process takes as little as 15 minutes or up to 10 hours at elevated temperature depending on the material. Conventionally, additional steps are also performed after the milling operation such as staining and glazing before the sintering is performed. These stain and glaze processes are performed by skilled technicians and the final dental prosthesis are typically of a high aesthetic quality.

Once the sintering process is completed the dental prosthesis is ready to be sent back to the dentist. The patient is brought back in, the temporary removed, and any residual adhesive cleaned off the surface of the prepared tooth. The dental prosthesis is checked for fit on the prepared tooth and the shade and aesthetics of the dental prosthetic are judged by the dentist. If fit and aesthetics are acceptable, the dental prosthesis is bonded in-place and the process is complete. It is not uncommon for some additional adjustments (e.g. grinding with a burr) to be made to the prepared tooth area or the dental prosthesis during the fitting process.

An alternative to the above approach is to take an intra-oral digital impression of the patient's prepared teeth and send the data file electronically, preferably via the internet to a CAD/CAM equipped lab. The steps for fabrication of a dental prosthesis are similar to those in the CAD/CAM example previously described with the exception that as a substitute for the stone dental working model, a physical dental working model is derived from the intra oral digital impression data and machined using a CNC mill. An alternative to the CNC fabricated working model is one created using stereolithography apparatus (SLA) or other 3D printing technique. Like the stone dental working model, the dental working model fabricated from the digital impression data may contain removable teeth to aid in manufacturing the dental prosthesis. The main advantage to this approach over the first CAD/CAM example is the elimination of taking the conventional impression, generally considered to be unpleasant by patients, and often a source of inaccuracies in the overall process—which leads to poor fits. Other advantages are the elimination of the impression shipping step and the step of scanning and converting the stone dental working model to a digital representation. An example of a commercially available intra-oral digital impression system used in this CAD/CAM approach is the Itero™ System (Cadent, Carlstadt N.J.).

Typically, after a tooth has been prepared and the impression taken, a provisional prosthetic (also known as a temporary) is fit to the prepared tooth. This temporary prosthesis serves to protect and limit the movement of the prepared tooth during the 5 to 10 days that a dental laboratory takes to fabricate and deliver the final prosthesis. Often times the temporary or provisional prosthetic will come loose and fall off which confronts the patient with the inconvenience of an unscheduled visit to the dentist or the choice to just leave the temporary off and take the risk of the prepared tooth being damaged or moving before the scheduled appointment to fit the final restoration. Any tooth movement can cause a poor fit of the final prosthetic and the need for adjustment (e.g. grinding the prosthetic or and/or the teeth with a burr) in order to ‘fit” the final dental prosthesis to the prepared dentition. When a dental prosthesis is adjusted to fit, the precision of the fabrication is lost and while the prosthesis made be “made to fit” by the dentist, the fit may be loose or require excess cement or bonding material which can in turn lead to a premature failure of the dental prosthesis or early decay around the joint where the prosthesis meets the natural tooth structure.

Yet another CAD/CAM approach is to install a digital impression system, a CAD design workstation and a computer controlled milling machine in the dentist's office. These systems are commercially available under the names; CEREC (Sirona, Gmbh) and E4D, (D4D Systems, Richardson, Tex.). The complete in-office systems allow the custom CNC manufacturing of inlays, onlays and full contour crowns derived from CAD designs based upon the digital impression data. The main advantage of these complete in-office systems is the ability to perform a complete restoration treatment in a single office visit. This is an advantage not only to the patient as they minimize trips to the dentist, but also for the dentist, since they can incur less patient handling and there is generally no need for a temporary prosthesis. There is also a potential cost savings to the dentist for the dental prosthesis provided they have sufficient treatment volume to cover the relatively high fixed cost of the CAD/CAM equipment. There are however several disadvantages as to this approach including: a) high initial equipment cost; b) steep learning curves for using the equipment, especially the CAD function for dental prosthesis design; and c) limited materials suitable for milling. Additionally, dentists owning in-office CNC restoration systems have reported that it can be challenging to train and retain dentist office personnel with the high level of skill needed to efficiently utilize such in office CNC restoration systems.

Considering that digital impression data is often only available after the tooth has been prepared, in the above CAD/CAM approaches, the external anatomy of the tooth being restored is typically created from a generic tooth library utilized during the CAD design process. In this case, the interface of the CAD designed dental prosthesis with the patient's opposing teeth may not match the opposing teeth through all the excursions of the jaw as well as the original tooth anatomy did. Over time, this situation can lead to excessive wear of the patient's dentition surfaces or even a failure of the final prosthesis due to high loads and stresses.

### SUMMARY

In one aspect, systems and methods are disclosed for manufacturing a dental prosthesis by capturing 3D dental data from a patient; sending the 3D dental data to a first facility for fabricating a restoration blank, the restoration blank having material extending beyond a preparation area; receiving the restoration blank at a second facility from the first facility; determining a reduction area from a 3D measurement of the patient's prepared dentition during an in dental office visit and fabricating a final dental prosthesis by machining the reduction area from the restoration blank to match the patient's prepared dentition. In this context, the first facility may include a dental laboratory, a general manufacturing facility, or a manufacturing facility focused on fabricating restoration blanks, for example. The second facility may include a dental office or a manufacturing facility in proximity to a dental office, for example.

In another aspect, systems and methods are disclosed for manufacturing a dental prosthesis, by taking an initial impression taken prior to preparation of the tooth being restored; creating a restoration blank at a dental laboratory (first facility in one embodiment) with a predetermined outside dentition shape using digital 3D surface information from the initial impression; taking a secondary impression after preparation of the tooth or teeth being restored; and modifying the restoration blank to form the restorative prosthesis at a dental office (second facility in one embodiment) using digital surface 3D information from the secondary impression.

In yet another aspect, a method for manufacturing a dental prosthesis where manufacturing of said prosthesis includes a first fabrication step to process a dental prosthesis material to create a restoration blank with a desired outside dentition shape using 3D digital surface information derived from an initial impression taken prior to preparation of the tooth or teeth being restored, and a second machining step of the restoration blank to produce a completed dental prosthesis using 3D digital surface information derived from a secondary impression where, said secondary impression is taken after preparation of the tooth or teeth being restored.

Implementation of the above systems can include one or more of the following. The 3D information for the shape of the first fabrication step is gathered using an initial elastomeric impression, which is converted into a digital representation of the patient's dentition. The digitization of the initial elastomeric impression, or the digitization of a dental working model cast from the initial impression, can use an optical scanner, an X-ray scanner, a coordinate measurement machine, or a computed tomography scanner. 3D information for the shape of the first fabrication step is gathered utilizing an intra-oral digital impression system. 3D information for machining the final shape of the dental prosthesis in the second machining step is captured using surface digitization of an elastomeric impression taken after the patient's tooth has been prepared by the dentist. The digitization of the elastomeric impression, or the digitization of a dental working model cast from the impression, can be performed using an optical scanner, an X-ray scanner, a coordinate measurement machine, or a computed tomography scanner. 3D information for machining the final shape of the dental prosthesis in the second machining step is preferably captured using an intra-oral digital impression system.

The first fabrication step of the restoration blank incorporates a framework in the restoration blank for orientation of the restoration blank in the second machining step. The framework may incorporate fiducial features used to orient the restoration blank in relation to additional machining operations. The restoration blank can be stained between the first fabrication step and the second machining step. The restoration blank can be glazed between the first fabrication step and the second machining step. The restoration blank can be fabricated from a pre-sintered ceramic material. The restoration blank can be heated to facilitate sintering of the ceramic between the first fabrication step and the second machining step. A cavity can be machined into the restoration blank in the first fabrication step to improve the process of machining the final shape of the dental prosthesis in the second machining step. Digital data can be transferred between a location performing the first fabrication step and a location performing the second machining step via internet, phone line or other digital transfer medium. Data for the shade and translucency characteristics desired for the final dental prosthesis can be included in said digital data transfer. The first fabrication step can machine the restoration blank from a solid ceramic substrate. The first fabrication step can create a 3D pattern representing the restoration blank where the 3D pattern is used to press or cast material to the restoration blank shape.

Advantages of the system may include one or more of the following.
The dentist can perform restoration treatment using an aesthetically pleasing and durable dental prosthesis in a single office visit without needing to perform the difficult and time consuming task of designing and manufacturing the complete dental prosthesis on-site in the dentist office.
The system allows for the inclusion of the patient's original tooth geometry in the design of the dental prosthesis which can greatly improve fit, aesthetics, and durability.
The system can use the original surface of the tooth being restored as a guide for creating the occlusal anatomy of the dental prosthesis and thereby prevent the anatomy of the dental prosthesis from interfering with opposing teeth.
The system provides a more flexible approach which combines the advantages of a single office visit restoration with the capabilities and efficiencies that a dental laboratory has to design and fabricate a high quality, aesthetic restoration.
The system eliminates the cost and inconvenience of a temporary prosthetic.
The system enables the dentist to fit the final prosthesis during the same office visit that the tooth was prepared, thereby reducing the possibility of tooth movements and the consequential need to adjust the fit.
When a dental prosthesis is adjusted to fit, the precision of the fabrication is lost and while the prosthesis made be “made to fit” by the dentist, the fit may be loose or require excess cement or bonding material which can in turn lead to a premature failure of the dental prosthesis or early decay around the joint where the prosthesis meets the natural tooth structure.
The system eliminates the need to stock millable restoration materials at the dentist office for a chairside mill. The need for stain and glaze materials and a sintering oven at the dentist office is eliminated. The time it can take to sinter the green state prosthetic material to its final hard state is eliminated at the dentist office.

### BRIEF DESCRIPTION OF THE DRAWINGS

FIG. 1 shows a perspective view of an exemplary restoration blank ready for incorporation into an orientation framework.

FIGS. 2A-2F show exemplary surface data capture and CNC machining operations on a model.

FIG. 3 shows an exemplary process to fabricate a dental prosthesis.

### DESCRIPTION

A system and method for manufacturing a dental prosthesis is described. In this exemplary system, the majority of the design and fabrication of the dental prosthesis is performed at a dental laboratory. The prosthesis is initially manufactured with additional excess material below the gingival area such that the final dental prosthesis can be machined on-site at the dental office to provide the exact fit to the patient's prepared tooth. Using this method, a substantial portion of the design and manufacturing of the dental prosthesis is performed by skilled dental technicians at a dental laboratory, thus ensuring that the aesthetic qualities of the final dental prosthesis are of a high quality. Also, since the dental laboratory has specialized materials, equipment, and processes for manufacturing, they can perform this portion of the fabrication of the dental prosthesis more efficiently than systems which rely on the dental office staff and equipment for the complete manufacturing process.

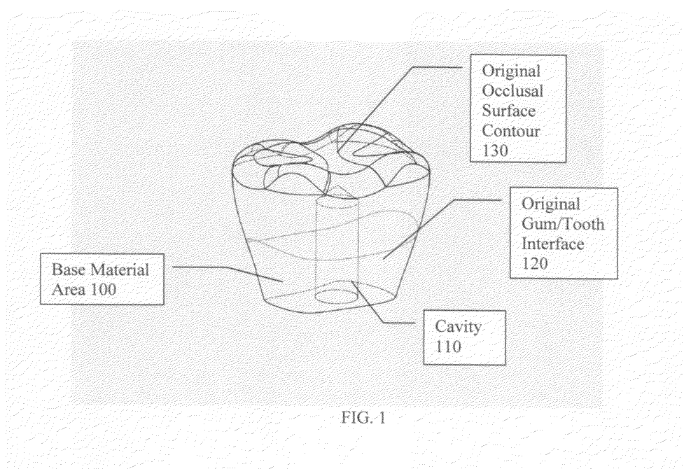

FIG. 1 shows a drawing of an exemplary restoration blank ready for incorporation into the orientation framework. The restoration blank includes a base region 100 with a cavity 110 centrally positioned in the base region 100. The cavity may be formed for example, by coring a hole in the base region 100 or the cavity may be formed directly if the restoration blank is fabricated by pressing or casting. The cavity 110 allows the blank to be mounted during manufacturing and also reduces the amount of machining required at the dentist office to complete the dental restoration for fitting to the stump of a patient's prepared tooth. A witness line 120 representing the original tooth gum interface is shown on the blank. The restoration blank of FIG. 1 has material that extends below the gum line. The occlusal surface 130 of the restoration blank has been fabricated to match the original occlusal surface of the patient's dentition before the tooth has been prepared.

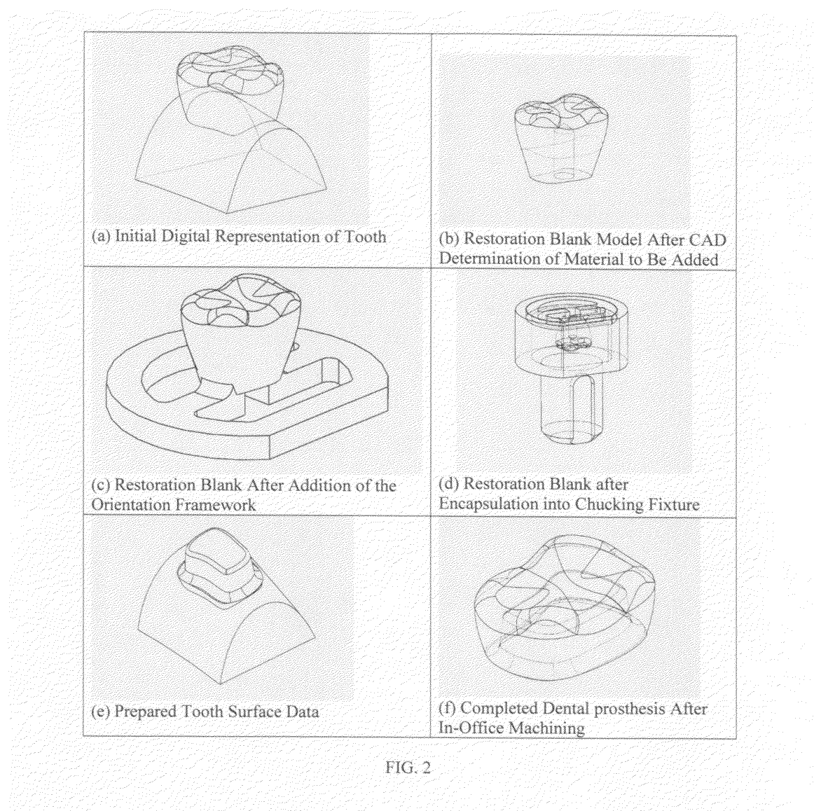

FIGS. 2(a)-2(f) show an exemplary system for surface data capture and CNC machining operations for manufacturing a dental prosthesis. Initially, the system performs the digitization and 3D modeling of the patient's dentition. In the preferred embodiment, this is performed at the dentist office using an intra-oral digitization unit to capture an initial baseline digital impression of the patient's dentition before any teeth are prepared for a restoration. For example, the initial baseline digital impression may be taken during a patient's routine cleaning and check up office visit similar to the way X-rays are taken in the office to characterize the current condition of the dentition. By capturing this baseline digital impression of the patient's teeth, the dentist has a digital record of the natural shape and position of the patient's dentition before any tooth surfaces are altered during the restoration process. Subsequently, when a tooth requires restoration, the initial baseline digital impression data can be used to design a dental prosthesis that replicates the size, anatomy, and functionality of the patient's original tooth.

When a specific tooth or teeth have been found to need a restoration, the digital data from the patent's baseline impression are used by the dentist to order a restoration blank from the dental laboratory, and the dental laboratory can use the baseline data to design and manufacture the restoration blank to have an external surface shape that generally matches the surface anatomy of the original tooth as captured in the initial baseline impression. Along with the patient's initial impression data, additional information would be provided to the dental laboratory such as the desired shade and translucency characteristics and the type of material to be used for fabricating the dental prosthesis.

Continuing with FIGS. 2(a)-2(f), FIG. 2(a) represents the digital 3D model of a portion of dentition derived from an initial baseline impression taken before the tooth has been prepared for the restoration. FIG. 2(b) shows an exemplary restoration blank to be fabricated by the dental lab. FIG. 2(c) represents an orientation framework added to the restoration blank. The operation of adding the orientation framework could be done in conjunction with the design of the restoration blank model shown in FIG. 2(b) using CAD design software. FIG. 2(d) shows the restoration blank encapsulated in the machining (chucking) fixture and FIG. 2(e) shows a representation of the patient's prepared tooth ready for the intra-oral scan. FIG. 2(f) shows the final dental prosthesis after machining using the in-office CNC milling machine.

The ordering of the restoration blank by the dentist could be done in advance of the patient's appointment for the tooth restoration treatment as it's not uncommon to plan for this type of treatment in advance. For example, a dentist may plan to do the tooth restoration treatment in conjunction with the next cleaning appointment planned for the patient. Once the dentist places the order, the dental lab creates the restoration blank with sufficient material left for machining the restoration blank to create the mating surface where the final dental prosthesis is bonded to the prepared surface of the tooth being restored. The restoration blank contains a feature or framework such that it can be oriented during a secondary CNC machining step at the dentist's office, ensuring the additional surfaces are machined accurately in relation to surface created during the initial fabrication at the lab.

In a preferred embodiment, the dental laboratory would perform the step of inserting and encapsulating the restoration blank into a chucking fixture that provides the interface for mounting and indexing the restoration blank to the in-office CNC mill's chuck. FIG. 2(d) illustrates an exemplary system for encapsulating a restoration blank in a chucking fixture. Alternately, the restoration blank can be installed and encapsulated into the chucking fixture after the restoration blank is received at the dentist office.

Once the restoration blank arrives at the dentist office, the dentist would schedule the patient and perform the necessary preparation to the tooth to remove any decay or damaged tooth surface and shape the tooth to accommodate the installation of a dental prosthesis. After the dentist has completed the tooth preparation, an impression is taken of the prepared tooth. In a preferred embodiment, the impression of the prepared tooth is taken using a digital intra-oral impression system that provides an immediate digital 3D model of the patient's prepared tooth and the teeth surfaces adjacent to the tooth being restored. A software program then aligns the 3D model of the prepared tooth and adjacent teeth with the digital 3D model of the same dentition derived from the initial baseline impression taken before the tooth being restored was prepared. The alignment results are then used to determine the location and volume of excess material that must be machined from the restoration blank such that the final dental prosthesis can precisely fit the patient's prepared tooth stump. A cutting file is generated for the in-office CNC machine containing the area and volume of material to be removed from the restoration blank. The restoration blank is then loaded into the in-office CNC mill and machining of the restoration blank necessary to create the final dental prosthesis is performed using the previously determined cutting file for the CNC mill. Upon completion of the machining, the now final dental prosthesis is removed from the chucking fixture, cleaned, and is ready for fitting and bonding.

Advantages of the system may include one or more of the following. Since only the interface to the prepared tooth surface needs to be machined at the dentist office, the in-office CNC milling machine can be simplified to utilize only 3 axes of motion. When compared to the 4 or 5 axis CNC milling machine typically used to machine a complete, full-contour dental prosthesis, this system reduces the cost and complexity of the in-office milling machine used at the dental office. Further, if only the interface to the prepared tooth surface is required to be machined into the final dental prosthesis at the time of the restoration treatment appointment, the time spent in the dental office can be significantly shorter in comparison to a process where the complete full-contour dental prosthesis is designed and fabricated from a solid block of material in the dentist office. Advantages of the system also include that there is no need for the dental office to maintain the large inventory of milling blocks that cover the broad range of block materials, sizes and shades that are required to be ready to perform the appropriate restoration treatment for a particular patient. Since the restoration blank is made at a dental laboratory using highly skilled technicians, the quality and appearance of the final prosthesis will generally be improved over a dental prosthesis designed and fabricated at a dentist office. The restoration treatment of anterior teeth with good aesthetics are possible with this system and method. The system avoids the need for a highly experienced technician at the dentist's office to design, mill, stain and glaze and fire the dental prosthesis. There is no need for a temporary prosthesis, which is prone to falling off and requires additional labor and material to produce, to be placed on the patient. There is no need for the patient to be rescheduled to come back to have the temporary prosthesis removed and a final dental restoration fitted and placed.

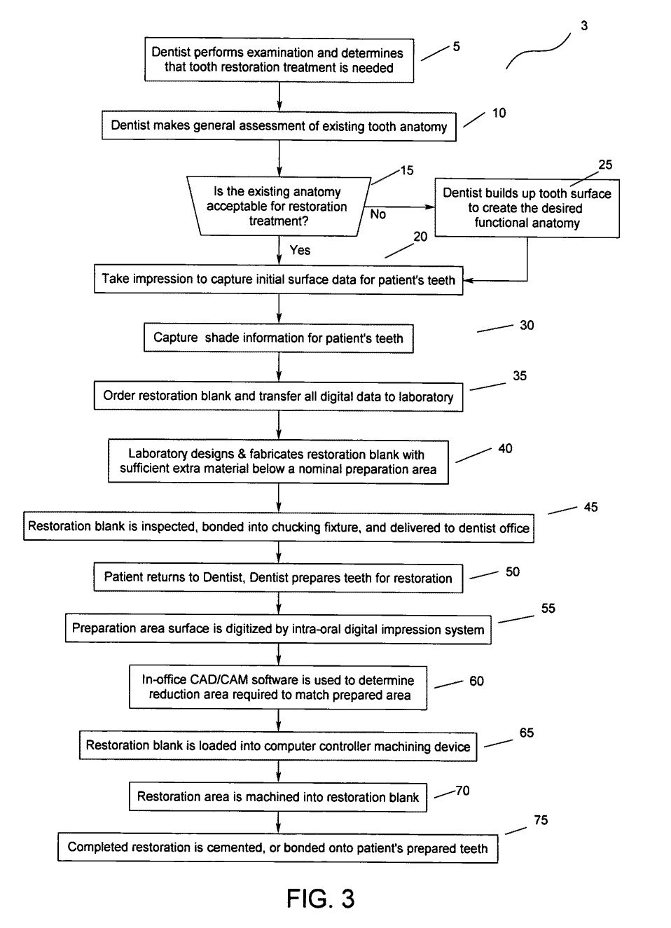

FIG. 3 shows representative process steps for the systems and methods. The process 3 starts with the dentist performing an examination and determining that tooth restoration treatment is needed 5. The dentist next makes an assessment of the patient's existing tooth anatomy 10. If the dentist determines that the existing tooth anatomy is acceptable to replicate with the dental prosthesis 15 then the dentist takes an impression to obtain the initial surface data for the patient's teeth 20. Ideally, these initial steps occur during a routine cleaning and check-up appointment since the data required initially is of the external dentition surfaces only. In a preferred embodiment, a complete baseline intra-oral digital impression is taken of the patient's dentition and stored on file in the event that a restoration treatment is needed at some point in the future. This stored baseline impression data would also prove useful if damage occurred to the patient's teeth due to an accident. Although the preferred method of capturing this initial impression is via an intra-oral digital impression system, a traditional elastomeric impression could also be utilized and digitized either directly, or from a poured stone dental model if so desired. An exemplary intra-oral digital impression system applicable for use in the invention is disclosed in U.S. Pat. No 6,592,371, Durbin, et al, the content of which is incorporated by reference. Along with the digital surface shapes data, additional information would be captured and provided to the dental laboratory such as tooth shade and tooth translucency 30. The dentist would order a restoration blank from the lab and all necessary data would be transferred to the dental laboratory 35.

Returning back to step 15, if the dentist determines that the general anatomy of the tooth needing restoration has functional deficiencies, the dentist may choose to build up the tooth surface to create the desired functional anatomy 25. For example, if there is damage to the tooth, breakage or otherwise malformed anatomy, the dentist may choose to use a composite filling material to build up the tooth as desired. This process of adding material allows for the dentist to restore missing features and anatomy or repair structure and check for any problems with opposing teeth in-situ under the full excursion of the jaw motion. This rebuilding process would be done prior to the initial surface scan to ensure that the new structure was captured in the restoration blank model scan. It is also possible to skip any rebuilding process and allow the dental technician at the lab to generate any missing anatomy digitally using a CAD design software program.

Continuing now with the process at the dental laboratory, the laboratory would use the data transferred from the dentist to design and manufacture the restoration blank with a portion of the restoration surface extending sub-gingivally, including a cavity from the sub gingival surface with sufficient room for machining in the mating surface where the dental prosthesis will ultimately be bonded to the prepared surface of the tooth 40. This additional extended area is determined in software from the initial tooth 3D surface data and the location of the tooth/gum interface. The amount of additional material added to the sub-gingival area is determined from empirical data of a “worst case” preparation and ensures that there is sufficient material to machine off for a variety of tooth preparations, including sub-gingival preparations. A cavity is included in the bottom of the restoration blank to allow for faster machining once the restoration blank has been sintered into the hard state since the cutter would not be required to plunge directly down into the solid surface of a hardened material. It is well known in art of machining of hard materials that the cutting speed in the center of a cutter tool becomes infinitely slow in the center of the rotating portion, making material removal in that area difficult and slow. If the machining can take place on the outer portion of the cutter tool, where the surface speeds are higher, cutting speeds can be increased and tool life extended.

Once the restoration blank is fabricated, it is stained and glazed for aesthetic purposes and fired to increase strength. The restoration blank is inspected for quality and bonded into a holding (chucking) fixture, which facilitates loading of the part into the in-office CNC machine, and the restoration blank and chucking fixture is shipped back to the dentist 45.

During the restoration treatment appointment, the dentist would perform the necessary preparation to the patient's tooth to remove any decay or damaged surface and prepare the surface for the restoration 50. Once complete, the preparation site is then scanned using the intra-oral digital impression system 55. The following software operations can be performed either on-site on the CAD/CAM workstation or at a remote location if needed. The software program aligns the pre-preparation scan of the restoration blank and the post-preparation scan along with the surface file for the machined area to be removed to match the preparation surface. The area of reduction to be removed from the restoration blank is then calculated and a cutting file is generated for the CNC mill 60. In a preferred embodiment this process would require little if any human intervention.

The restoration blank, which is mounted in the chucking fixture holder, is loaded into the CNC milling equipment 65. The holder allows the restoration blank to be oriented in the mill accurately such that the milling cutter can machine the material reduction where needed with respect to the external surfaces of the prepared tooth. In a preferred embodiment, the milling machine would be fitted with a locating probe which would measure fiducial features machined into the framework to aid in further locating the part in the machine's coordinate system. These types of measurement systems are commonly referred to as Coordinate Measurement Machines (CMM) and their use is well know to those skilled in the art of machining. Once mounted in the in-office CNC mill, the reduction area and contact area where the tooth meets adjacent teeth are machined to the shape defined by the digital file generated 70. The finished dental prosthesis is then un-mounted from the holder, cleaned, fit checked, and cemented in the patient's mouth 75.

An alternative method for the dental laboratory to fabricate the restoration blank is by means of pressable ceramics such as the IPS e.max product, (Ivoclar Vivadent, Amherst, N.Y.) or castable ceramics. In this process, a master pattern of the restoration blank is created using a CNC machined wax or rapid prototype stereo lithography or 3D printing technique. The pattern is then used to create a cavity in a plaster mold after a burn out process. After curing the plaster mold, a ceramic material is pressed or cast into the cavity under high temperature to fill the void left by the wax. This process can be performed to create the entire dental prosthesis, or as a coping which would then be processed with additional layers of ceramic to give the desired aesthetic properties. In either case, the pattern would include the framework and fiducial features necessary to orient and process the part in the in-office CNC mill.

Next, a method for manufacturing a dental restorative prosthesis is described where manufacturing of the prosthesis includes a first fabrication step to process a prosthesis material to create a restoration blank with a desired outside dentition shape using digital surface information from an initial impression taken prior to preparation of the tooth or teeth being restored, and a second machining step of the restoration blank to produce a completed dental prosthesis using digital surface information from a secondary impression where, said secondary impression is taken after preparation of the tooth or teeth being restored.

The information for the shape of the first fabrication can be gathered using a conventional impression, and converted into a digital representation. The digitization can use an optical scanner, a coordinate measurement machine, or a computed tomography scanner. In the preferred embodiment, the information for the shape of the initial machining step is gathered utilizing an intra-oral scanning system. The final preparation machining information can also be captured using surface digitization of a conventional impression. The digitization step can use an optical scanner, a coordinate measurement machine, a computed tomography scanner, or in the preferred approach, an intra-oral scanner. The first fabrication of the restoration blank incorporates a framework for orientation in the second machining operation. The framework incorporates fiducial features used to orient the part in relation to additional machining operations. The restoration blank can be stained between the first fabrication step and the second machining step. The restoration blank can be glazed between the first fabrication step and the second machining operations. The restoration blank can be heated to facilitate sintering of a ceramic material between the first fabrication step and the second machining operations. A cavity, hole or cored out section can be machined or formed into the restoration blank in the first fabrication step to improve the process of machining in the second machining operations. Digital data can be transferred between a location performing the first fabrication and a location performing the second machining operation via internet, phone line or other digital transfer medium. Data for the shade of the tooth can be included in said digital data transfer. The first fabrication operation can machine the restoration blank from a solid ceramic substrate. The first fabrication can create a 3D pattern and press or cast material to said restoration blank shape.

It is to be understood that various terms employed in the description herein are interchangeable. Accordingly, the above description of the invention is illustrative and not limiting. Further modifications will be apparent to one of ordinary skill in the art in light of this disclosure.

The invention has been described in terms of specific examples which are illustrative only and are not to be construed as limiting.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A method for manufacturing a dental restorative prosthesis, comprising:
a. capturing an initial impression of a patient's dentition taken prior to preparation of a tooth being restored;
b. creating a restoration blank at a first facility with a predetermined outside dentition shape using digital surface information derived from the initial impression;
c. taking a secondary impression of the dentition after preparation of the tooth or teeth being restored; and
d. modifying the restoration blank to form the restorative prosthesis at a second facility remote from the first facility using digital surface information derived from the secondary impression.

2. The method of claim 1 where the initial impression comprises an elastomeric impression, comprising measuring the elastomeric impression with an optical scanner, a coordinate measurement machine, or a computed tomography scanner and converting the measurements into a digital representation of the patient's dentition.

3. The method of claim 1 where the initial impression comprises an elastomeric impression, comprising casting a dental model from the elastomeric impression and measuring the cast dental model with an optical scanner, a coordinate measurement machine, or a computed tomography scanner and converting the measurements into a digital representation of the patient's dentition.

4. The method of claim 1, comprising capturing the initial impression with an intra oral digital impression system that provides a digital representation of the patient's dentition.

5. The method of claim 1, comprising capturing the secondary impression with an intra-oral digital impression system.

6. The method of claim 1, comprising forming a framework in the restoration blank for subsequent orientation.

7. The method of claim 6, comprising incorporating fidicial features in the framework to orient the restoration blank.

8. The method of claim 1, comprising staining a portion of the restoration blank prior to modifying the restoration blank.

9. The method of claim 1, comprising glazing a portion of the restoration blank prior to modifying the restoration blank.

10. The method of claim 1, comprising fabricating the restoration blank from a ceramic material.

11. The method of claim 10, comprising using the ceramic material in a pre-sintered state.

12. The method of claim 11, comprising heating the restoration blank to facilitate sintering of the ceramic material prior to modifying the restoration blank.

13. The method of claim 1, comprising forming a cavity in the restoration blank to improve machining of the restoration blank.

14. The method of claim 1, wherein the first office comprises a dental lab and the second office comprises a dental office, comprising transferring digital data between the dental office and the dental lab over the internet, a telephone line or a digital transfer medium.

15. The method of claim 14, comprising transmitting tooth shade information in the digital data transfer.

16. The method of claim 1, comprising
a. creating a 3D pattern from the information derived from the initial impression; and
b. pressing or casting the 3D pattern to form the restoration blank.

17. A method for manufacturing a dental restorative prosthesis, comprising:
capturing 3D dental data representing a patient's dentition;
sending the 3D dental data to a laboratory for fabricating a restoration blank, the blank having material extending below a preparation area;
receiving the restoration blank from the laboratory;
determining a reduction area needed to modify the restoration blank to fit a patient's dentition prepared for the restoration during an in-office visit and
fabricating a dental prosthesis by removing the reduction area from the restoration blank to match the patient's prepared dentition.

18. The method of claim 17, comprising capturing shade information for the patient's dentition.

19. The method of claim 17, comprising bonding the restoration blank to a holding fixture.

20. The method of claim 17, comprising modifying the restoration blank by machining the restoration blank at the dental office using computer controlled machine.
